(19) United States
(12) Patent Application Publication
(10) Pub. No.: US 2009/0113041 A1
(43) Pub. Date: Apr. 30, 2009

(54) SYSTEM AND METHOD FOR PROVIDING AN INTELLIGENT WIRELESS NETWORK

(76) Inventor: Andre Andreazzi, Sao Paulo (BR)

Correspondence Address: HOFFMAN WARNICK LLC, 75 STATE ST, 14 FL, ALBANY, NY, 12207, US

(21) Appl. No.: 11/930,407

(22) Filed: Oct. 31, 2007

(51) Int. Cl. G06F 15/173

(52) U.S. Cl. 709/224

(57) ABSTRACT

A system and method is for identifying where an employee is located and which network services node, such as a printer, is near him/her through a access point. The system uses the connection between the access point to identify the location of the user and which printer he/she can use. The main network server transmits the information to the wireless router providing the network access to the user and updates the database with the user and localization.

### FIELD OF THE INVENTION

The present invention relates generally to wireless networks and, more specifically, a system and method for providing an intelligent wireless network.

### BACKGROUND OF THE INVENTION

Presently, with wireless network access, users can work in different places every day. For instance, mobile users use “mobile centers” to perform such actions as printing. To print in the mobile center, the user needs to install the drivers and set up the printer in his laptop. The issue is, any time the user moves, the user needs to install a different printer driver. (A printer driver or a print processor is a piece of software that converts the data to be printed to the form specific to a printer. The purpose of printer drivers is to allow applications to do printing without being aware of the technical details of each printer model.)

With the popularization of the wireless networks inside and outside companies, users are working in a different place or office every day. But the users cannot print or use other network functions once they are out of office or in a different office.

Another issue is that some users are “addressless” and the system finds it is difficult to find a user personally and it is difficult to know, as an example, if the user is in or outside of the office.

There is a present need for the user who has a wireless network covering a considerable area and having WIFI providers who provide for their customers the print service adding printing points around the city so that the clients (e.g., PDAs, phones or PCs) can use the nearest printer.

### BRIEF SUMMARY OF THE INVENTION

The present invention is a system and method for identifying where a user is located and which printer is near him/her through a connection point which the network is able to identify. In a wireless network, the client (e.g., PDAs, phones or PCs) has a connection point, normally a wireless router, using PCs as example of the client. The wireless router is connected to the main network which can provide all access and authenticate the user. The system and method of the present invention allows the use of the connection between the router (or user access point) to identify the location of the user and to identify which printer he/she can use. The user accesses the router requesting network access; the wireless router sends the information to the main network server which authenticates the user. The main network server sends back the information to the wireless router providing the network access to the user and updates the database with the user and the user's location. The router establishes a connection with the user and the network. The main network identifies the location of the user is based on the wireless router the user used to access the network. A previous set up is used to identify each access point and to create a relation with the covered area.

The illustrative aspects of the present invention are designed to solve one or more of the problems herein described and/or one or more other problems not discussed.

### BRIEF DESCRIPTION OF THE SEVERAL VIEWS OF THE DRAWINGS

These and other features of the invention will be more readily understood from the following detailed description of the various aspects of the invention taken in conjunction with the accompanying drawings that depict various embodiments of the invention, in which:

FIG. 1 depicts a data processing system suitable for storing and/or executing program code.

FIG. 2 illustrates a preferred embodiment of the system for providing an intelligent wireless network of the present invention.

FIG. 3 illustrates a basic network showing various network connections, network services and user clients.

FIG. 4 illustrates a data processing unit, located in the cross-section of two covered areas and accessing, in two different moments, two different access points.

The drawings are intended to depict only typical aspects of the invention, and therefore should not be considered as limiting the scope of the invention. In the drawings, like numbering represent like elements between the drawings.

### DETAILED DESCRIPTION OF THE INVENTION

The present invention provides a system and method for providing an intelligent wireless network.

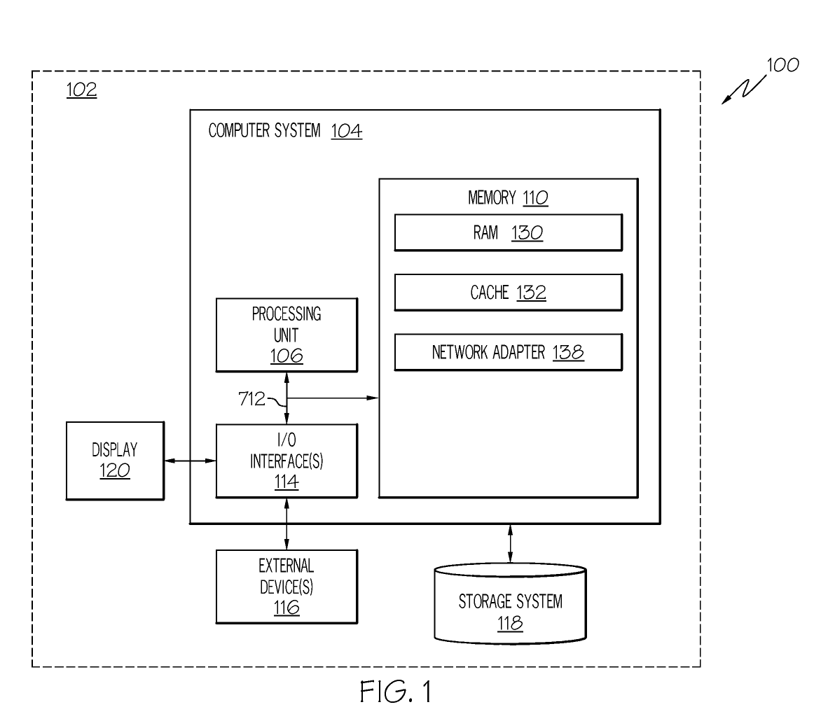

A data processing system, such as that system 100 shown in FIG. 1, suitable for storing and/or executing program code will include at least one processor (processing unit 106) coupled directly or indirectly to memory elements through a system bus. The memory elements can include local memory (RAM 130) employed during actual execution of the program code, bulk storage (storage 118), and cache memories (cache 132) which provide temporary storage of at least some program code in order to reduce the number of times code must be retrieved from bulk storage during execution. Input/output or I/O devices (external devices 116) (including but not limited to keyboards, displays, pointing devices, etc.) can be coupled to the system either directly or through intervening I/O controllers (I/O Interface 114).

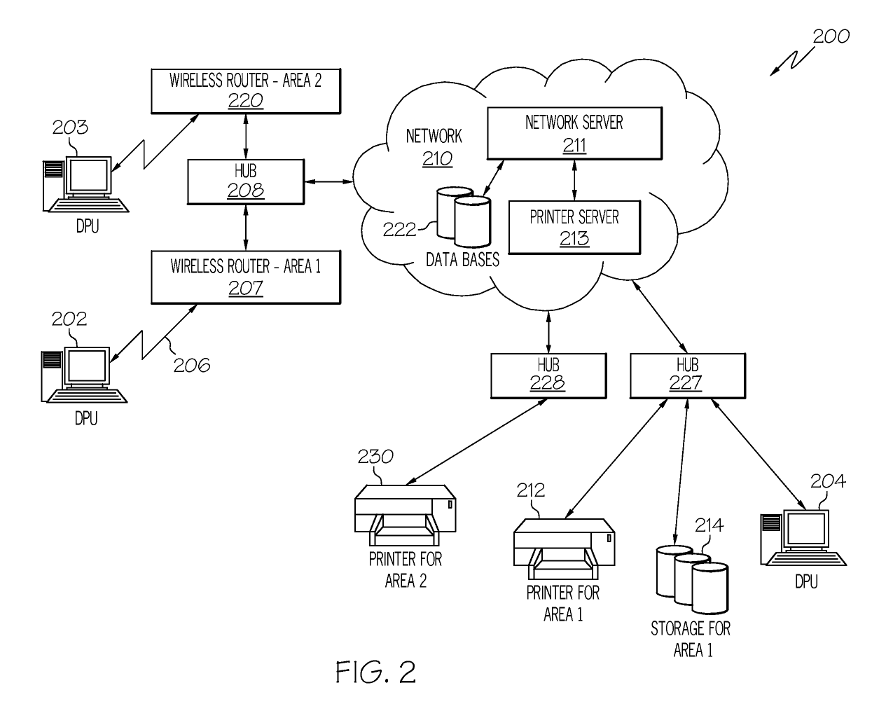

Network adapters (network adapter 138) may also be coupled to the network 210 system to enable the data processing system (as shown in FIG. 2, data processing unit 202, DPU 203) to become coupled to other data processing systems (DPU 204) or remote printers (printer 212, printer 230) or storage devices (storage 214 for area 1) through intervening private or public networks (network 210). (A computer network is composed of multiple computers connected together using a telecommunication system for the purpose of sharing data, resources and communication. For more information, see http://historyoftheinternet.org/). Wireless modems, wireless adaptors, cable modem and Ethernet cards are just a few of the currently available types of network adapters. (A wireless network card, wireless network adapter or NIC (network interface card) is a piece of computer hardware designed to allow computers to communicate over a computer network. It is both an OSI layer 1 (physical layer) and layer 2 (data link layer) device, as it provides physical access to a networking medium and provides a low-level addressing system through the use of MAC addresses. It allows users to connect to each other either by using cables or wirelessly.)

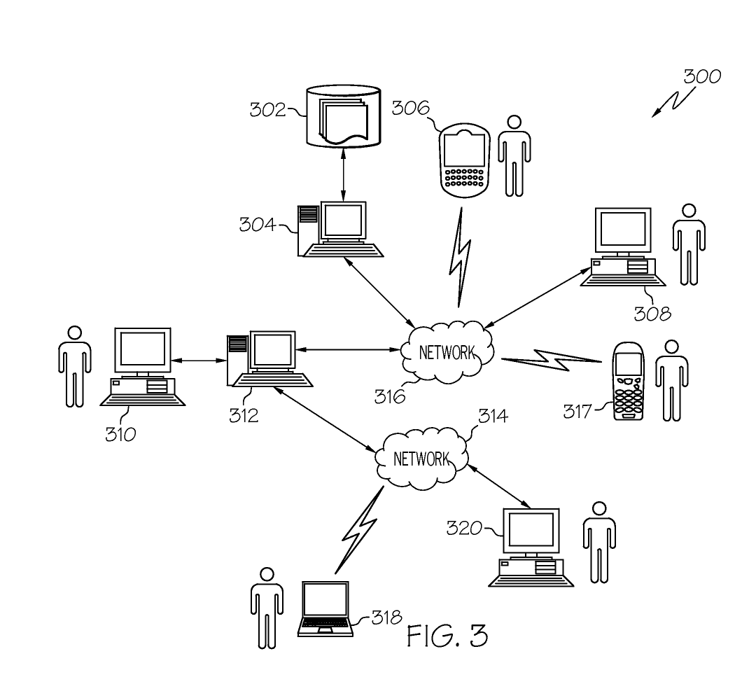

FIG. 3 illustrates a basic network showing various network connections, network services and user clients. System 300 has networks 314, 316 which interconnect to each other as to interconnect user clients via a wireless connection from such user clients as laptop 318, mobile phone 317 or PDA 306. The networks 314, 316 further interconnect, via hard line connection, workstations 320, 308 and servers 304, 312. Servers 304, 312 serve workstation 310 and storage unit 302.

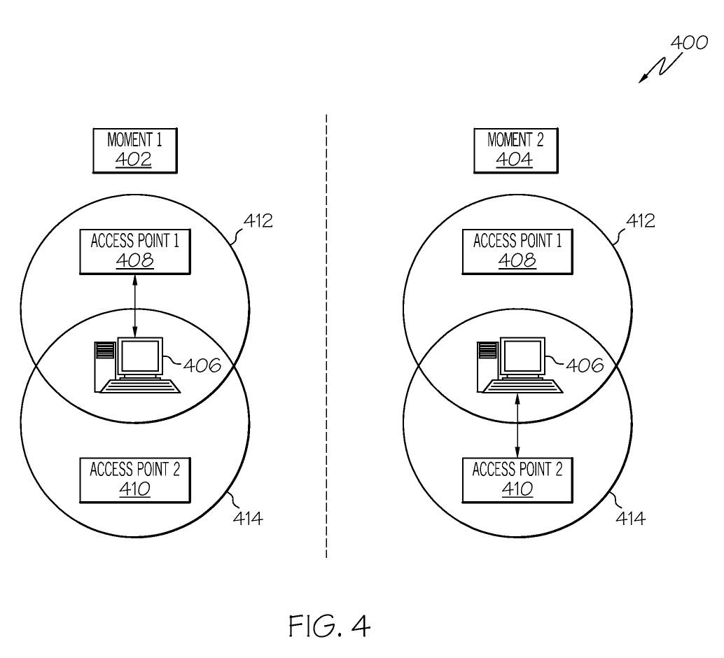

FIG. 2 illustrates the system and method of the present invention. The system comprises data processing unit (DPU) 202, DPU 203, DPU 204. As shown in FIG. 3 discussed above, user clients can be laptops, PDAs, mobile phones, etc., as well. DPUs 202, 203 are connected to a network 210 wirelessly through wireless routers 207, 220. The network 210 may comprise different types of servers such as network server 211 and, in the preferred embodiment of the present invention, a print server 213. (A server computer (often called server for short) is a computer system that has been designated for running a specific server application or applications. A computer that is designated for only one server application is often named for that application. For example, when Apache HTTP Server (software) is a company's web server, the computer running it is also called the web server. A print server, or printer server, is a computer or device to which one or more printers are connected, which can accept print jobs from external client computers connected to the print server over a network. The print server then sends the data to the appropriate printer that it manages.) Wireless routers 207, 220 support physical areas (such as Area 1 and Area 2 (see Covered Area 1 412, Covered Area 2 414 as shown FIG. 4) and, in the present example, Wireless Router Area 1 207 supports physical Area 1 412 and Wireless Router Area 220 supports physical Area 2 414. Both Wireless Router Area 1 207 and Wireless Router Area 220 connect to Network 210 via Hub 208. (A “hub” is a common connection point for devices in a network.) Network Server 211 processes any requests, such as print requests, utilizing, e.g., Databases 222 and Print Server 213 and the request is routed, via Hub 227 (which supports Area 1 412) and Hub 228 (which supports Area 2 414), to end nodes (e.g., Printer 212 for Area 1, Storage 214 for Area 1, DPU 204, and Printer 230 for Area 2).

The process of the present invention comprises the following steps:
1. The user, utilizing data processing unit 202, requests accesses to the network 210 through the wireless router 207 (wireless router 207 is the entrance for the network 210 for wireless users located in Area 1);
2. A connection is made to network 210 through hub 208;
3. Once the connection is established to the main network server 211, network server (NS) 211 receives the new access request through wireless access point (wireless router 207) and establishes the connection;
4. After establishing the connection, NS 211 determines that the connection is being requested through wireless router 207 which covers Area 1;
5. Once the wireless router 207 is identified and network server 211 determines that the user 202 is located in Area 1 (using the FIG. 2), network server 211 updates the “user database” (databases 222) with the user id and localization id and the connection process is finished;
6. Using printing as an example of network service—user 202 sends a print request;
7. NS 211 identifies the print request from wireless router Area 1 207 and the user ID (if the user 202 starts the connection on Area 1 and requests the printing through wireless router Area 2 220, the “user database” (databases 222) is updated with the new information);
8. The NS 211 selects the default printer 212 for Area 1 as the printer 212 for that request and informs user 202 that the document is being printed on default printer 212 for Area 1;
9. The user 202 receives a message that the document is being printed on default printer 212 for Area 1 and can click “OK” or “Cancel” (if more than one printer can be used the message sent to the user show all printer options and the user can select clicking “OK”); and
10. Clicking “OK”, the print request is sent to the selected printer;

The implementation process, in the network server 211, is as follows:

1. Identify all wireless routers and areas;
2. Identify at least one default printer per area; and
3. Set up the system with the information gathered on steps 1 and 2.

The start system/process, in the network server 211, is as follows:

1. The database for the application to store the area, wireless access point, default printers and user information are identified;
2. The network server 211, which has an agent, identifies the connection through the wireless access point (e.g., wireless router area 1 207, wireless router area 2 220), and accesses the database (databases 222) to identify the area of the wireless access point and the area covered;
3. The agent updates the database (databases 222) with the area where the user is located;
4. The agent identifies the print request from wireless access point (e.g., wireless router area 1 207, wireless router area 2 220) and from user;
5. The agent selects the printer (e.g., printer area 1 212, printer area 2 230) to be used to the print request;
6. The agent informs the user which printer will be used (if more than one the user can select within the options);
7. The user's client (e.g., DPU 202, DPU 203 or, alternatively, any other wireless device such as cell phones, PDAs, etc.) accesses the intelligent network so that the user can send a print request without any printer set up in the PC or other equipment; and
8. The network server 211 accesses the user localization information.

FIG. 4 illustrates DPU 406, located in the cross-section of Covered Area 1 412 and Covered Area 2 414, accessing, in Moment 1, Access Point 1 412 (corresponding to Wireless Router—Area 1 207) and accessing, in Moment 2, Access Point 2 414 (corresponding to Wireless Router—Area 2 220). As shown in FIG. 2, depending upon which access point is accessed, services supporting the selected area (such as Printer 212 for Area 1, Printer 230 for Area 2) would be utilized.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

1. A method, utilizing an intelligent wireless network having at least one network server and at least one network services server, such as a printer server, and further having at least one wireless access point, such as a wireless router, for connecting user nodes, such as laptop computers, PDAs, and mobile phones, to network services nodes, such as printing services nodes and data storage nodes, each wireless access point supporting a physical area, intelligent wireless network further having databases for storing information related to the network including user node information, the method comprising the steps of:
a) the network server identifying all wireless access points and areas covered by each wireless access point;
b) the network server identifying at least one default network services node, such as a default printer, per covered area; and
c) the network server storing the information gathered in steps a and b in the databases.

2. The method of claim 1 further comprising step d of the network server receiving a request for network services from a user node, the network server storing the physical area in which the user node is located based upon which wireless access point was accessed in the databases, and forwarding the network services request to the appropriate network services node supporting the physical area in which the user node is located.

3. The method of claim 2 wherein the network services request is a print request and the network services node is a default printer.

4. The method of claim 2 wherein the network services request is a data store request and the network services node is a default database associated with the user node.

5. The method of claim 3 further comprising the step of the network server identifying the print request from wireless access point and from user node.

6. The method of claim 5 further comprising the step of the agent identifying the print request from the wireless access point.

7. The method of claim 6 wherein the system further comprises a print server and the method further comprises the steps of the network server selecting the printer to be used to the print request.

8. The method of claim 7 further comprising the steps of the network server informing the user which printer will be used and allowing the user to select which printer will be used if there are more than one printer is available serving that physical area.

9. The method of claim 8 further comprising the step of the network server receiving the printer selection from the user and sending, via the print server, the print request to the selected printer.

10. A computer program comprising program code stored on a computer-readable medium, which when executed, enables a computer system to implement the following steps in a method utilizing an intelligent wireless network having at least one network server and at least one network services server, such as a printer server, and further having at least one wireless access point, such as a wireless router, for connecting user nodes, such as laptop computers, PDAs, and mobile phones, to network services nodes, such as printing services nodes and data storage nodes, each wireless access point supporting a physical area, intelligent wireless network further having databases for storing information related to the network including user node information, the method comprising the steps of:
a) the network server identifying all wireless access points and areas covered by each wireless access point;
b) the network server identifying at least one default network services node, such as a default printer, per covered area; and
c) the network server storing the information gathered in steps a and b in the databases.

11. The computer program product of claim 10 where the method further comprises step d of the network server receiving a request for network services from a user node, the network server storing the physical area in which the user node is located based upon which wireless access point was accessed in the databases, and forwarding the network services request to the appropriate network services node supporting the physical area in which the user node is located.

12. The computer program product of claim 11 wherein the network services request is a print request and the network services node is a default printer.

13. The computer program product of claim 11 wherein the network services request is a data store request and the network services node is a default database associated with the user node.

14. The computer program product of claim 13 wherein the method further comprises the step of the network server identifying the print request from wireless access point and from user node.

15. The computer program product of claim 14 wherein the method further comprises the step of the agent identifying the print request from the wireless access point.

16. The computer program product of claim 15 wherein the system further comprises a print server and the method further comprises the steps of the network server selecting the printer to be used to the print request.

17. The computer program product of claim 16 wherein the method further comprises the steps of the network server informing the user which printer will be used and allowing the user to select which printer will be used if there are more than one printer is available serving that physical area.

18. The computer program product of claim 17 wherein the method further comprises the step of the network server receiving the printer selection from the user and sending, via the print server, the print request to the selected printer.

19. A system for implementing a computer program comprising program code stored on a computer-readable medium, which when executed, enables the system to implement the following steps in a method utilizing an intelligent wireless network, the system comprising:
a) at least one network server for communicating with at least one wireless access point, such as a wireless router, for connecting user nodes, such as laptop computers, PDAs, and mobile phones, to network services nodes, such as printing services nodes and data storage nodes, each wireless access point supporting a physical area;
b) at least one network services server, such as a printer server; and
c) databases for storing information related to the network including user node information,
wherein the network server identifies all wireless access points and areas covered by each wireless access point, identifies at least one default network services node, such as a default printer, per covered area, stores the information gathered in the databases, receives a request for network services from a user node, stores the physical area in which the user node is located based upon which wireless access point was accessed in the databases, and forwards the network services request to the appropriate network services node supporting the physical area in which the user node is located.

20. The system of claim 19 wherein the network services request is a print request and the network services node is a default printer.
